(19) United States
(12) Patent Application Publication
(10) Pub. No.: US 2003/0008794 A1
(43) Pub. Date: Jan. 9, 2003

(54) Rinse-aid composition containing a bio-polypeptide

(75) Inventor: Bingham Scott Jaynes, New City, NY (US)

Correspondence Address: UNILEVER, PATENT DEPARTMENT, 45 RIVER ROAD, EDGEWATER, NJ, 07020, US

(73) Assignee: Diversey Lever, Inc.

(21) Appl. No.: 09/891,851

(22) Filed: Jun. 26, 2001

(51) Int. Cl. C11D 1/00

(52) U.S. Cl. 510/220; 510/392

(57) ABSTRACT

A rinse-aid composition having a bio-polypeptide is described. The rinse-aid composition unexpectedly results in dishware that does display improved starch soil removal and does not display starch buildup after multiple washes.

### FIELD OF THE INVENTION

This invention is directed to a rinse-aid composition, and a method for improving starchy soil removal and preventing starch build-up on articles being cleaned. More particularly, the invention is directed to a superior rinse-aid composition that comprises a bio-polypeptide. The rinse-aid composition unexpectedly results in dishware that does display improved starchy soil removal and does not display starch build-up after multiple washing cycles.

### BACKGROUND OF THE INVENTION

Traditional industrial and domestic dishwashing systems rely on a combination of high alkalinity detergent washes and chlorine bleach for cleaning and sanitizing dishware. Such systems perform well on bleachable stains; however, they tend to be deficient in removing starchy soils like those often found on dishware in domestic kitchens, hospitals, cafeterias, catering industries and the like.

Other attempts have been made to create dishwashing systems that are effective at handling starchy soils. These systems typically employ commercially available enzymes that break down the starchy soil in the various wash cycles of the dishwashing systems they are employed in. The enzymes used in systems for treating starchy soils on dishware are generally not limited to and include those that typically break or hydrolyze the α-1,4-glycosidic linkages of the starch backbone.

In addition to being sanitized, it is very desirable for dishware exiting dishwashing systems to be dry with a glossy finish. These characteristics are often achieved by employing rinse-aid compositions in the final rinse step of the dishwashing system.

Unfortunately, however, it has been discovered that conventional rinse-aid and detergent washes typically result in dishware with non-appealing characteristics. This is true because conventional detergent washes are not always effective at removing starchy soils from the dishware they are employed to clean. Also, studies indicate that conventional rinse-aid compositions can result in poor starch removal on dishware subject to as little as one cleaning cycle.

It is of increasing interest to develop rinse-aid compositions that maintain their conventional characteristics and do not adversely interfere with the cleaning process of a dishwashing system. Also, it is of increasing interest to develop methods that induce starchy soil removal and prevent starch build-up on articles, such as dishware, being cleaned. The inventions described herein, therefore, are directed to a superior rinse-aid composition, and a method for improving starchy soil removal and preventing starch build-up on articles. Such inventions are achieved by employing a rinse-aid composition that comprises a bio-polypeptide.

Additional Information

Methods have been disclosed for cleaning plasticware. In U.S. Pat. No. 5,603,776, plasticware is cleaned by subjecting the same to an alkaline aqueous cleaning agent and an aqueous rinse comprising nonionic surfactant, fluorinated hydrocarbon surfactant and polyalkylene oxide-modified polydimethylsiloxane.

Further, rinse-aid compositions that comprise a modified polydimethylsiloxane have been disclosed. In U.S. Pat. No. 5,880,089, a rinse-aid composition with a modified polydimethylsiloxane or a polybetaine-modified polysiloxane, a fluorinated hydrocarbon nonionic surfactant and a nonionic block copolymer of ethylene oxide and propylene oxide is disclosed.

Still further, in U.S. Pat. No. 5,880,088, rinse-aid compositions that comprise a polyether or polybetaine polysiloxane copolymer, hydrotrope and nonionic block copolymer of ethylene oxide and propylene oxide are disclosed.

Also, in European Patent Application EP 1028150 A2, protective and shiny coatings with water-soluble polymers are disclosed.

The prevention of starchy soil build-up, and starchy soil removal (with a bio-polypeptide) on articles being cleaned has not been addressed in the above-described references. The present inventions, therefore, are distinguishable from the above-described since, for example, they are directed to starchy soil removal and the prevention of starch build-up on articles being cleaned, particularly by using a rinse-aid composition comprising a bio-polypeptide in a dishwashing system. Moreover, the present inventions display superior results without requiring the addition of a starch or starch comprising additive, like corn starch, or Hi Cap (as made commercially available by National Starch).

### SUMMARY OF THE INVENTION

In a first embodiment, the present invention is directed to a rinse-aid composition comprising bio-polypeptide wherein the rinse-aid composition comprising the bio-polypeptide prevents starch build-up and improves soil removal on articles being washed.

In a second embodiment, the invention is directed to a method for using the rinse-aid composition described in the first embodiment of this invention.

In a third embodiment, the invention is directed to a method for preventing starch build-up on articles being cleaned by applying a pre-coating composition on to the articles being cleaned wherein the pre-coating composition comprises a bio-polypeptide.

As used herein, bio-polypeptide is defined to mean an additive for a rinse-aid composition wherein the additive has at least one amide bond and at least two amino acids. Starchy soil and starch soil, as used herein, are defined to mean a soil consisting only of starch or a soil comprising starch such as a starch and fat mixture (e.g., Roux Blanc). Use solution is defined to mean a rinse-aid composition and water mixture which is applied to the dishware being cleaned in conventional dishwashing systems.

### DETAILED DESCRIPTION OF THE PREFERRED EMBODIMENTS

The only limitation with respect to the bio-polypeptide that may be used in this invention is that the bio-polypeptide aids in starchy soil removal and/or starch build-up on dishware being cleaned, and is safe for use in a dishwasher.

Illustrative examples of the bio-polypeptide that may be used in the present invention include those of collagenic origin, like gelatin, animal glue, collagen or collagen hydrolysate. Other bio-polypeptides which may be used in this invention include egg albumin, bovine serum albumin, yeast proteins, whey proteins, casein (including sodium caseinate) and vegetable proteins, like soybean proteins. Even other bio-polypeptides which may be used in this invention include plant proteins such as oilseed proteins obtained from plants of cotton, palm, rape, safflower, cocoa, sunflower and the like. The bio-polypeptides which may be used in this invention may be present individually or in the form of a bio-polypeptide mixture.

In a preferred embodiment, the bio-polypeptide used in the present invention is gelatin, egg albumin, bovine serum albumin or casein. In a most preferred embodiment, the bio-polypeptide used in this invention is casein.

The non-plant derived bio-polypeptide which may be used in this invention is typically obtained from raw materials like hide, bone, blood, egg whites, milk and the like. Moreover, the bio-polypeptides used in this invention are commercially available from suppliers like Fisher and Sigma-Aldrich Chemical.

The rinse-aid composition of this invention, which comprises at least one of the above-described bio-polypeptides, may also comprise conventional rinse-aid additives, including acids, alcohols, hydrotropes, preservatives, surfactants and water. The acids which may be employed in the rinse-aid composition of this invention include those that are commercially available. Often, when preparing the rinse-aid compositions of this invention, about 0.0% to about 40.0%, and preferably, from about 1.0% to about 30.0%, and most preferably, from about 5.0% to about 20.0% by weight of acid is employed based on total weight of the rinse-aid composition, including all ranges subsumed therein. An illustrative list of the acids which may be used in this invention include hydroxy acids like malic acid, lactic acid, citric acid, glycolic acid, tartaric acid and the like. Citric acid, however, is often the most preferred hydroxy acid. Other acids that may be used include mineral acids like hydrochloric acid, sulfuric acid, phosphoric acid and nitric acid.

Often, the pH of the use solution comprising the rinse-aid composition of this invention is from about 1.5 to about 10.0, and preferably, from about 4.0 to about 7.0, and most preferably, from about 5.0 to about 7.0, including all ranges subsumed therein.

The alcohols which may be employed in this invention include, for example, C₁-C₈ primary, secondary or tertiary alcohols. Such alcohols are commercially available. Isopropanol, however, is often the most preferred alcohol. When alcohols are employed in rinse-aid compositions, the rinse-aid compositions often employ from about 0.0% to about 20.0%, and preferably, from about 0.5% to about 10.0%, and most preferably, from about 1.0% to about 5.0% by weight alcohol based on total weight of the rinse-aid composition.

The hydrotropes which may be employed in this invention are limited only to the extent that they enhance the solubility of the bio-polypeptides and other components in the rinse-aid composition of this invention. The hydrotropes which may be used in this invention are those which are commercially available, and an illustrative list includes sodium xylene sulfonate, sodium cumene sulfonate, hexylene glycol, propylene glycol, dihexyl sodium sulfonate and low molecular weight sulfates. Other useful hydrotropes which may be employed in this invention include those described in U.S. Pat. Nos. 3,563,901 and 4,443,270, the disclosures of which are incorporated herein by reference.

When hydrotropes are employed in the rinse-aid composition of this invention, they often represent from about 0.1% to about 65.0%, and preferably, from about 2.0% to about 30.0%, and most preferably, from about 5.0% to about 15.0% by weight of the total weight of the rinse-aid composition, including all ranges subsumed therein.

The preservatives which may be used in the rinse-aid composition of this invention include ascorbic acid, erythorbic acid, sorbic acid, thiodipropionic acid, ascorbyl palmitate, butylated hydroxyamisol, butylated hydroxytoluene, calcium ascorbate, calcium sorbate, dilauryl thiodipropionate, methyl chloro isothiazolinone, methyl isothiazolinone, potassium bisulfate, potassium metabisulfate, potassium sorbate, sodium ascorbate, sodium bisulfate, sodium meta bisulfite, sodium sorbate, sodium sulfite, sulfur dioxide, tocophenols and Group IA salts (e.g., potassium chloride) and IIA salts (e.g., magnesium chloride). When preservatives are used in the rinse-aid composition of this invention, they typically make up about 0.01% to about 0.2%, and preferably, from about 0.02% to about 0.1%, and most preferably, from about 0.04% to about 0.08% by weight of the total rinse-aid composition, including all ranges subsumed therein.

The surfactants that may be used in this invention are limited only to the extent that they do not interfere with the benefits obtained when using the rinse-aid of the present invention. Such surfactants are commercially available and may be cationic, anionic, amphoteric, zwitterionic, or nonionic in nature. Preferred surfactants are low-foaming nonionics that may be generally classified as alkoxylated alcohols. Preferred alkoxylated alcohols include those sold under the name Pluronic and Plurafac (sold by BASF); Synperonic (sold by ICI); Surfonic (sold by Huntsman) and UCON (sold by Dow Chemical). The amount of surfactant present in the rinse-aid composition of this invention is from about 2.0 to about 50.0%, and preferably, from about 4.0 to about 40.0%, and most preferably, from about 10.0 to about 30.0% by weight, based on total weight of the rinse-aid composition.

When water is employed in the rinse-aid composition of this invention, it generally is the solvent making up the balance of the composition.

The rinse-aid composition of this invention may be prepared via any of the art recognized techniques. Essentially, the components (e.g., bio-polypeptide, water) of the composition are, for example, mixed, stirred or agitated. The rinse-aid composition of this invention may be made at ambient temperature, atmospheric pressure or at any pressure or temperature variations which may result in the rinse-aid compositions of this invention. The addition of the components is not limited to any particular order, with the proviso that the resulting composition is one which may be employed as a rinse-aid composition that prevents starch build-up in cleaning systems.

The amount of bio-polypeptide employed in the rinse-aid composition of this invention is limited only to the extent that the amount employed results in improved starchy soil removal.

Typically, from about 0.5% to about 30.0%, and preferably, from about 0.75% to about 10.0%, and most preferably, from about 1.0% to about 5.0% by weight of the rinse-aid composition is bio-polypeptide, based on total weight of the rinse-aid composition, including all ranges subsumed therein. Often the use solution comprising the rinse-aid composition of this invention comprises from about 1.0 ppm to about 100,000 ppm, and preferably, from about 2.0 to about 500 ppm, and most preferably, from about 15 to about 200 ppm, including all ranges subsumed therein.

When conducting the method for preventing starch build-up on dishware in this invention, the method comprises the steps of:

a) contacting dishware with the rinse-aid composition of this invention; and

b) removing the dishware from the rinse-aid composition.

When conducting the method of this invention, the dishware being cleaned (e.g., knives, pots, pans, forks, spoons, glasses, mugs, cups, china, dishes or plastic kitchen utensils) in, for example, a dishwasher, is often subjected to at least one cycle selected from the group consisting of a presoak cycle, a wash cycle and a rinse cycle, followed by a final rinse cycle. In a most preferred embodiment, the rinse-aid composition of this invention is used in the final rinse cycle.

The wash cycle which precedes the rinse having the rinse-aid composition of this invention is typically run from about 5.0 seconds to about 15 minutes, and preferably, from about 10 seconds to about 12 minutes, and most preferably, from about 30 seconds to about 10 minutes in an industrial system, including all ranges subsumed therein.

In a domestic system, the wash cycle is typically run from about 2 minutes to about 45 minutes, and preferably, from about 5 minutes to about 35 minutes, and most preferably, from about 8 minutes to about 30 minutes, including all ranges subsumed therein.

The final rinse cycle when using the rinse-aid composition of this invention is typically run for about 5 to about 90 seconds in industrial systems and for about 2 minutes to about 25 minutes in domestic systems, and preferably, for about 10 seconds to about 60 seconds in industrial systems and about 5 minutes to about 20 minutes in domestic systems, and most preferably, from about 7 seconds to about 12 seconds in industrial systems and from about 10 minutes to about 15 minutes in domestic systems, including all ranges subsumed therein.

The temperature of the wash cycle (in industrial and domestic systems) is typically from about ambient to about 80° C., and preferably, from about 35° C. to about 70° C., and most preferably, from about 55° C. to about 65° C., including all ranges subsumed therein. The temperature of the final rinse (which uses the rinse-aid composition of the invention) is usually from about ambient to about 100° C., and preferably, from about 30° C. to about 95° C., and most preferably, from about 40° C. to about 85° C., including all ranges subsumed therein, whereby the dishware being cleaned is typically dipped in and/or sprayed with the rinse-aid composition of this invention. The final result of such a method is clean dishware with a glossy finish, whereby starch removal has been enhanced and starch build-up has been prevented, and the dishware dries in about substantially the same time as clean dishware that has not been subjected to the rinse-aid composition of this invention but has been subjected to a commercially available composition.

As to the dishwashers, for example, that are used with the method of this invention, such dishwashers include those which are made commercially available from manufacturers including KitchenAid, Bendix Appliances, Electrolux, Meiko, Hobart, Winterhalter, Equator Appliance, Frigidaire, Champion and the like.

It is noted herein, that the bio-polypeptide described in this invention may be present in the rinse-aid composition or dosed in a precursor rinse-aid composition at about the time the composition is to enter the dishwasher.

Moreover, the dishware cleaned via this invention (or cleaned via any conventional process) may be pretreated, prior to being subjected to soil, with a pre-coating composition. Such a method employs the steps of pre-coating non-soiled dishware with a pre-coating composition which comprises:

(a) a bio-polypeptide; and

(b) water.

The pre-coating composition may be applied to the dishware being cleaned via any art recognized technique. Typically, the dishware is dipped or sprayed with the optional pre-coating composition.

The amount of optional pre-coating composition applied is only limited to the extent that the pre-coating composition coats the surface of the dishware and does not interfere with the dishware's conventional use. Often, the precoating composition comprises from about 0.50 to about 30.0% by weight bio-polypeptide, including all ranges subsumed therein.

The following examples are provided for illustrative purposes, and are not intended as a restriction on the scope of the invention. Thus, it is obvious that various changes may be made to the specific embodiments of this invention without departing from its spirit. Accordingly, the invention is not to be limited to the precise embodiments shown and described, but only as indicated in the following claims.

### EXAMPLE 1

Six (6) sets, four (4) ceramic plates each, were pre-washed in a standard industrial dishwashing detergent (made commercially available by Diversey Lever, Suma Brand) and rinsed with a use solution having hot water (about 70° C.) containing about 50 ppm gelatin (Type A). The rinse step for each set was carried out at pH 8, pH 5 and pH 3 for set 1, 2 and 3, respectively. A control set for each experiment was rinsed with hot water (about 70° C.) (no gelatin) adjusted to the pH levels above.

After drying, the dishes were soiled (2.0 grams of soil applied with a paint brush) with a potato starch slurry (67.0 g potato starch powder from Sigma-Aldrich and 1.0 liter of water heated to about 95° C. for 5.0 minutes), and allowed to stand overnight. The dishes were then washed in the detergent above and enzyme (20 ppm amylase). The plates were scored for residual soil by dipping the plates in an iodine solution (1.25 grams I₂ and 9.2 grams KI per liter of water) and visually assessing the plates for purple color. Cleaning results are illustrated in Table 1. Residual soil levels were reduced 44% when the gelatin coating was applied at pH 8 and by 100% when the coating was applied at pH 5 or pH 3.

TABLE 1
Residual potato starch soil level on plates after
pre-treatment with gelatin solutions at varying pH.

| | Residual Soil Level | | |
|---|---|---|---|
| | after Washing (%) | | |
| | pH 8 | pH 5 | pH 3 |
| Control | 62 | 45 | 45 |
| Gelatin Coated | 35 | 0 | 0 |

### EXAMPLE 2

Two (2) sets, four (4) plates each, were pre-washed with the detergent of Example 1 and then pre-coated with 100 ppm use solutions (pH about 8), the first set with gelatin and the second set with casein (sodium caseinate) as the bio-polypeptides and subsequently soiled with potato starch as described in Example 1. After washing in detergent, the sets of plates were rinsed with the respective use solutions used to precoat the plates. After air drying, the plates were soiled for the next cycle. The soil/wash/rinse cycle was repeated three times (once a day for three (3) days), then the plates were scored for residual soil in the manner described above.

The residual soil levels after the three soil/wash/rinse cycles are shown in Table 2. Soil levels are substantially lower in the bio-polypeptide coated samples than in the (third set of plates) control (no bio-polypeptide used) set after each of the three cycles.

TABLE 2
Residual potato starch soil level on plates after three
wash cycles with bio-polypeptide in the rinse step (pH 8).

| | Residual Soil Level | | |
|---|---|---|---|
| | after Washing (%) | | |
| | Day 1 | Day 2 | Day 3 |
| Control | 38 | 58 | 80 |
| Gelatin Coated | 10 | 9 | 10 |
| Casein Coated | 4 | 13 | 18 |

### EXAMPLE 3

Two (2) sets of plates, four (4) plates each, were treated in a manner similar to the one described in Example 2, except that a 50 ppm solution of the bio-polypeptide was used in the pre-coat and rinse, and the pH was adjusted to 5 using citric acid.

The residual soil levels after the three soil/wash/rinse cycles are shown in Table 3. Soil levels are near zero when gelatin and casein were selected as the bio-polypeptides, whereas the control samples were 86% soiled.

TABLE 3
Residual potato starch soil level on plates after three
wash cycles with bio-polypeptide in the rinse step (pH 5).

| | Residual Soil Level | | |
|---|---|---|---|
| | after Washing (%) | | |
| | Day 1 | Day 2 | Day 3 |
| Control | 37 | 68 | 86 |
| Gelatin Coated | 0 | 0 | 1 |
| Casein Coated | 1 | 3 | 3 |

### EXAMPLE 4

Two (2) sets, four (4) plates each, were pre-washed in an industrial dishwashing detergent (Diversey Lever, Precision Advantage) and rinsed with a use solution having hot water (about 70° C.) and 100 ppm egg albumin as the bio-polypeptide. The rinse step was carried out at pH 8 and pH 6.5, set 1 and set 2, respectively. A control set for each experiment was rinsed with water (no bio-polypeptide) adjusted to the pH levels described above. The pH was adjusted with citric acid.

After air drying, the treated plates were soiled with a composite soil (Roux Blanc about 15% plant fat), and heated for 1 hr at about 70° C. The plates were then washed in an industrial dishwasher with the detergent above and scored for residual soil in a manner similar to the one described in Example 1. Cleaning results are illustrated in Table 4. Residual soil levels were reduced by 60% for the egg albumin rinse at pH 8 and by 55% for the egg albumin rinse at pH 6.5.

TABLE 4
Residual composite fat/starch soil level on plates after
pre-treatment with egg albumin solutions at pH 8 and pH 6.5.

Residual Soil
after Washing (%)

| Coating | pH 8 | pH 6.5 |
|---|---|---|
| None | 18.75 | 25 |
| Egg Albumin | 7.5 | 11.25 |

### EXAMPLE 5

Two (2) sets, four (4) plates each, were pre-washed in an industrial dishwashing detergent (Diversey Lever, Suma Brand) and rinsed with hot water (about 70° C.) containing either 50 or 100 ppm bovine serum albumin as the bio-polypeptide. A control set of four (4) plates for each experiment was rinsed with water (no bio-polypeptide).

After air drying, the plates were soiled with potato starch slurry and allowed to stand overnight. The plates were then washed in the same detergent as above. The plates were evaluated as in Example 1. Cleaning results are illustrated in Table 5. Residual soil levels were reduced by 30% for the 50 ppm bovine serum albumin solution and by 47% for the 100 ppm bovine serum albumin solution.

TABLE 5
Residual potato starch soil level on plates after pre-treatment
with bovine serum albumin solutions at 50 and 100 ppm.

| | Residual Soil |
|---|---|
| Coating | after Washing (%) |
| Control | 86.5 |
| 50 ppm BSA | 60.3 |
| 100 ppm BSA | 45.5 |

What is claimed is:

1. A rinse-aid composition for a dishwashing machine comprising a bio-polypeptide wherein the rinse-aid composition prevents starch build-up and improves soil removal on articles being washed.

2. The rinse-aid composition according to claim 1 wherein the bio-polypeptide is gelatin, egg albumin, bovine serum albumin, casein, sodium caseinate or a mixture thereof.

3. The rinse-aid composition according to claim 1 wherein the bio-polypeptide is yeast protein, whey protein, vegetable protein, plant protein, animal glue, collagen, collagen hydrosylate, or a mixture thereof.

4. The rinse-aid composition according to claim 1 wherein the rinse-aid composition comprises from about 0.5% to about 30.0% by weight bio-polypeptide.

5. The rinse-aid composition according to claim 1 wherein the rinse-aid composition further comprises at least one additive selected from the group consisting of an alcohol, hydrotrope, preservative, acid, surfactant and water.

6. The rinse-aid composition according to claim 5 wherein the surfactant is a low-foaming nonionic surfactant.

7. The rinse-aid composition according to claim 1 wherein the rinse-aid composition results in a use solution having a pH from about 2.0 to about 10.0.

8. A method for preventing starch build-up on dishware comprising the steps of:
(a) contacting dishware with a rinse-aid composition comprising a bio-polypeptide;
(b) removing the dishware from the rinse-aid composition.

9. The method according to claim 8 wherein the bio-polypeptide is gelatin, egg albumin, bovine serum albumin, casein, sodium caseinate or a mixture thereof.

10. The method according to claim 8 wherein the bio-polypeptide is yeast protein, whey protein, vegetable protein, plant protein, animal glue, collagen, collagen hydrosylate, or a mixture thereof.

11. The method according to claim 8 wherein the rinse-aid composition comprises from about 0.5% to about 30.0% by weight bio-polypeptide.

12. The method according to claim 8 wherein the rinse-aid composition further comprises at least one additive selected from the group consisting of an alcohol, hydrotrope, preservative, acid, surfactant and water.

13. The method according to claim 8 wherein the surfactant is a low-foaming nonionic surfactant.

14. The method according to claim 8 wherein the rinse-aid composition results in a use solution having a pH from about 2.0 to about 10.0.

15. The method according to claim 8 wherein the rinse-aid composition is at a temperature from about ambient to about 100° C.

16. A method for pre-treating non-soiled dishware to prevent starch soil build-up comprising the steps of contacting non-soiled dishware with a pre-coating composition comprising:
(a) a bio-polypeptide; and
(b) water.

17. The method according to claim 16 wherein the bio-polypeptide is gelatin, egg albumin, bovine serum albumin, casein, sodium caseinate or a mixture thereof.

18. The method according to claim 16 wherein the bio-polypeptide is yeast protein, whey protein, vegetable protein, plant protein, animal glue, collagen, collagen hydrosylate, or a mixture thereof.

19. The method according to claim 16 wherein the pre-coating composition has from about 0.50 to about 30.0% by weight bio-polypeptide.

20. The method according to claim 16 wherein the pre-coating composition is sprayed on to the dishware.
